(19) United States
(12) Patent Application Publication
(10) Pub. No.: US 2017/0251255 A1
(43) Pub. Date: Aug. 31, 2017

(54) SYSTEM FOR TERMINAL RESOLUTION ADAPTATION FOR DEVICES

(71) Applicant: Sharp Kabushiki Kaisha, Sakai City, Osaka (JP)

(72) Inventors: Sachin G. DESHPANDE, Camas, WA (US); Kiran MISRA, Camas, WA (US); Christopher A. SEGALL, Camas, WA (US)

(21) Appl. No.: 15/508,162

(22) PCT Filed: Oct. 5, 2015
(86) PCT No.: PCT/JP2015/005064

§ 371 Date: Mar. 2, 2017

Related U.S. Application Data
(60) Provisional application No. 62/060,495, filed on Oct. 6, 2014.

(51) Int. Cl. H04N 21/4402; H04N 21/462; H04N 21/85; H04N 21/84; H04N 21/431; H04N 21/81

(52) U.S. Cl. CPC H04N 21/440263; H04N 21/4312; H04N 21/8146; H04N 21/85; H04N 21/84; H04N 21/4622; H04N 21/8166

(57) ABSTRACT

The present invention relates to a display system for displaying an image on a display comprising: (a) said display system includes physical information related to a physical resolution of physical pixels for said displaying said image on said display; (b) said display system includes logical information related to an application graphics plane that includes a graphics plane resolution of logical pixels; (c) said display system selects said image to be displayed within said application graphics plane on said display from a set of available images based upon said logical information related to said graphics plane resolution of logical pixels.

### BACKGROUND ART

The present invention relates to a system for terminal resolution adaptation for devices.

Broadcast environments include the ability to broadcast over-the-air (e.g., satellite broadcast and/or wireless broadcast and/or cellular broadcast) video content to a viewer and the ability to broadcast through a network connection (e.g., such as the Internet and/or cable connection and/or phone connection) to a viewer. The viewer may observe and interact with the content using a multitude of different devices. For example, the viewer may view the content on a television, may view the content on a desktop computer with a monitor, may view the content on a laptop, may view the content on a tablet, and/or view the content on a mobile device. In each of these cases, the capabilities of the viewing device tends to vary in the manner modifying how the video content may be presented. For example, the television may have a standard definition resolution, a high definition resolution, an ultra high definition relation, or otherwise. In most cases, the television reformats the video content to fit on the display so that it may be viewed in an acceptable manner. Unfortunately, the content being presented to the viewer which may be modified is often not provided in an optimal manner for the device upon which the content is being viewed.

What is desired, therefore, is a device that includes an improved preference system.

### SUMMARY OF INVENTION

One embodiment of the present invention relates to:

A display system for displaying an image on a display comprising:

(a) said display system includes physical information related to a physical resolution of physical pixels for said displaying said image on said display;

(b) said display system includes logical information related to an application graphics plane that includes a graphics plane resolution of logical pixels;

(c) said display system selects said image to be displayed within said application graphics plane on said display from a set of available images based upon said logical information related to said graphics plane resolution of logical pixels.

Another embodiment of the present invention relates to:

A display system for displaying an image on a display comprising:

(a) said display system includes physical information related to a physical resolution of physical pixels for said displaying said image on said display;

(b) said display system includes logical information related to an application graphics plane that includes a graphics plane resolution of logical pixels;

(c) said display system selects said image to be displayed within said application graphics plane on said display from a set of available images based upon a profile indicator of said display system.

### BRIEF DESCRIPTION OF DRAWINGS

FIG. 1 illustrates a broadcasting system.

FIG. 2 illustrates a broadcasting system enabling a user to use an application.

FIG. 3 illustrates a terminal.

FIG. 4 illustrates a terminal with multiple logical planes.

FIG. 5A illustrates a terminal, an application, together with physical information to select an image.

FIG. 5B illustrates another terminal, an application, together with physical and logical information to select an image.

FIG. 6A illustrates another terminal, an application, together with physical to select an image.

FIG. 6B illustrates another terminal, an application, together with physical and logical information to select an image.

### DESCRIPTION OF EMBODIMENTS

Part of the following description is provided, merely for the purpose of convenience, using the names of entities defined in the Hybrid Broadcast Broadband TV (HbbTV) standard. However, this should not be construed as limiting the scope of the disclosure and/or the claims. It is to be clearly understood that the disclosure and/or the claims are also equally applicable to any other suitable system.

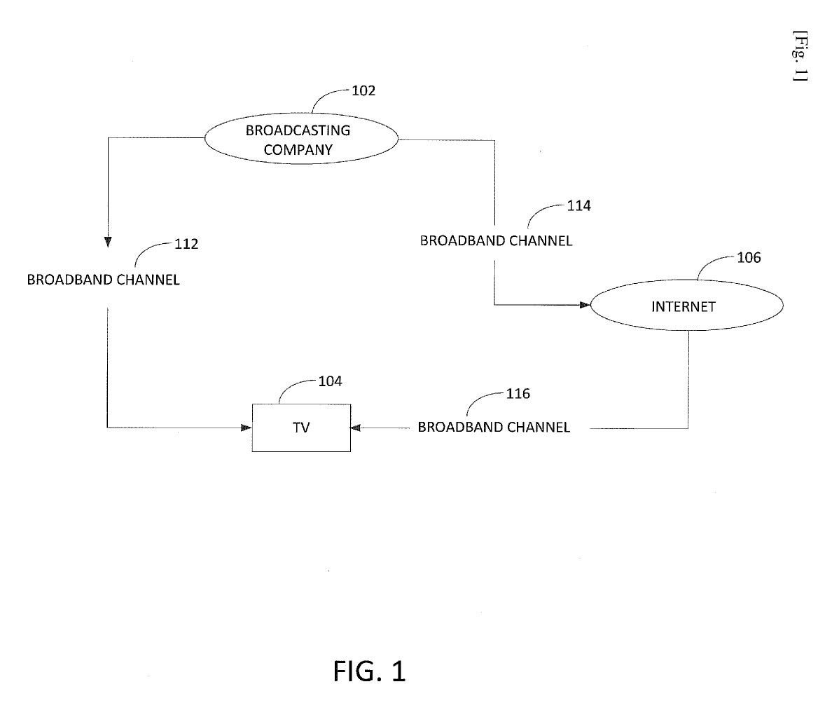

FIG. 1 illustrates an exemplary configuration of a HbbTV network. A TV 104 may receive a broadcasting service including audio and/or video (A/V) content from a broadcasting company 102 through a broadcast channel 112 and/or a broadband channel 116. The broadcast channel 112 refers to a channel provided over a broadcasting network. The broadband channel 116 may be an interactive channel provided over an interactive network, such as for example, a cellular system. The broadcasting company 102 transmits metadata of an application related to broadcast content. The application includes various types of information such as a Web page and an application program related to the broadcast content, which can be executed in the TV 104. The TV 104 may execute the application using the metadata. Content of the application may be provided to the TV 104 through at least one of the broadband channel 116 and the broadcast channel 112. If the application is provided through the broadband channel 116, the broadcasting company 102 (or an application provider) provides the application to the TV 104 over the Internet 106 connected through a broadband channel or other communications means (e.g. a backbone network) via a broadband channel 114. The TV 104 may communicate with the broadcasting company 102 through at least one of the two channels during execution of the application.

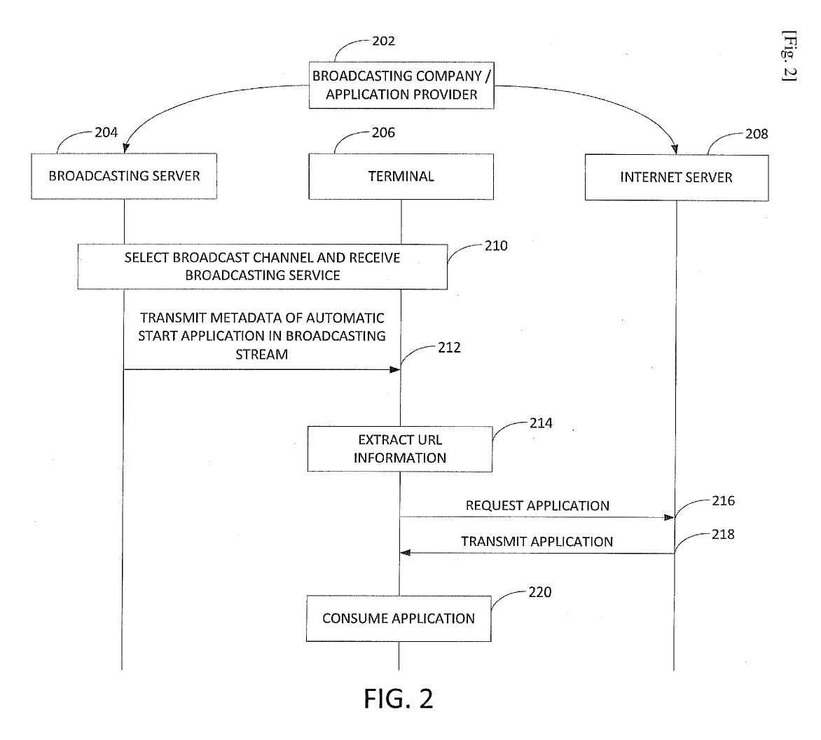

FIG. 2 illustrates an exemplary operation enabling a user to use an application over a broadband network during broadcasting. A broadcasting company/application provider 202 has interfaces with a broadcasting server 204 that provides a broadcasting stream and an Internet server 208. A user terminal 206 may be, for example, a TV, a mobile device, or other device that can receive a broadcasting service. The terminal 206 selects a desired broadcast channel and starts to receive a broadcasting stream of a broadcasting service on the selected broadcast channel from the broadcasting server 204 at operation 210. At operation 212, the broadcasting server 204 transmits a broadcasting stream including metadata of an automatic start application to the terminal 206.

At operation 214, the terminal 206 extracts the Internet address of the Internet server 208 that provides applications, for example, a Uniform Resource Locator (URL) or Uniform Resource Identifier (URI) from metadata. The terminal 206 then requests an application to the Internet server 208 corresponding to the URL at operation 216. The Internet server 208 provides the requested application to the terminal 206 at operation 218 and the terminal 206 consumes, that is, executes the application at operation 220. The terminal 206 may communicate with the broadcasting company 202 through at least one of a broadcast channel and a broadband channel during execution of the application.

In many environments, in the operation of FIG. 2, the terminal 206 may not transmit user information and/or device information about the terminal 206 to the Internet server 208 and the Internet server 208 provides a uniform application to the terminal 206 with no regard to the user environment and/or device environment of the terminal 206.

A terminal may receive an application which has been customized in consideration of a user environment and/or device environment of the terminal. For example, an application adapted to a screen size may be provided to a terminal, depending on whether the device type of the terminal is a TV or a mobile device or depending on a resolution characteristic of the terminal. In another example, an application including information about famous restaurants or weather may be provided to a terminal according to the current location of the terminal. In another example, an application including an advertisement of a preferred product may be provided to a terminal according to the age, gender, and viewing history of a user of the terminal.

To receive a customized application to a terminal, the terminal acquires the address, i.e. URL of an Internet server configured to provide customized applications. The address of an Internet server capable of providing customized applications may be referred to as a customization URL and the Internet server is configured so as to configure a customized application based on user information and/or device information and provide the customized application to a terminal. The customization URL is provided to the terminal by the metadata of an automatic start application transmitted by a broadcasting server. In another embodiment, the customization URL may be transmitted in a different path, for example, through the Internet server or an offline leaflet, or pre-stored in the terminal.

Table 1 below illustrates an exemplary metadata including a customization URL.

TABLE 1

| application_type | | As required, eg Flash or |
|---|---|---|
| | | hypertext markup language |
| | | (HTML) |
| application_control_code | | Not used |
| Customization URL | | Address of the server that |
| | | manages user/device data |
| Customization Parameter | | The application can be |
| | | customized with this |
| | | parameter |
| application_descriptor( ) | | |
| | application_profile_length | 0 (no application profile |
| | | provided) |
| | service_bound_flag | Set as required |
| | Visibility | Not used |
| | application_priority | Set as required |
| | transport_protocol_label | At least one |

transport_protocol_descriptor( )

| | protocol_id | 0x03 (broadband server) |
|---|---|---|
| | selector_bytes | Carry the min. application |
| | | version |
| simple_application_location_descriptor( ) | | |
| | initial_path_bytes | Parameters for the |

application

Referring to Table 1, the metadata includes application type indicating the type of the application, for example, flash or Hyper Text Markup Language (HTML), application descriptor that describes the application, transport_protocol_descriptor that describes a transport protocol, and simple_application_location_descriptor indicating the position of the application. The metadata also includes Customization URL indicating the address of an Internet server that manages user information and/or device information and provides customized applications. In another embodiment, the metadata may further include a Customization Parameter that specifies a reference parameter used to customize an application. Customization Parameter may indicate, for example, at least one of device type, user location, user gender/age, and a viewing history as a reference used to customize an application in the Internet server and/or the terminal.

The terminal may transmit user information or device information to the Internet server indicated by the URL acquired from the metadata. In another embodiment, the Internet server may acquire the user information or the device information about the terminal from a broadcasting server or a subscriber management server that manages subscription information about terminals. In another embodiment, the Internet server may acquire the user information or the device information about the terminal by other means. If desired, the broadcasting company may provide a customized application to the terminal.

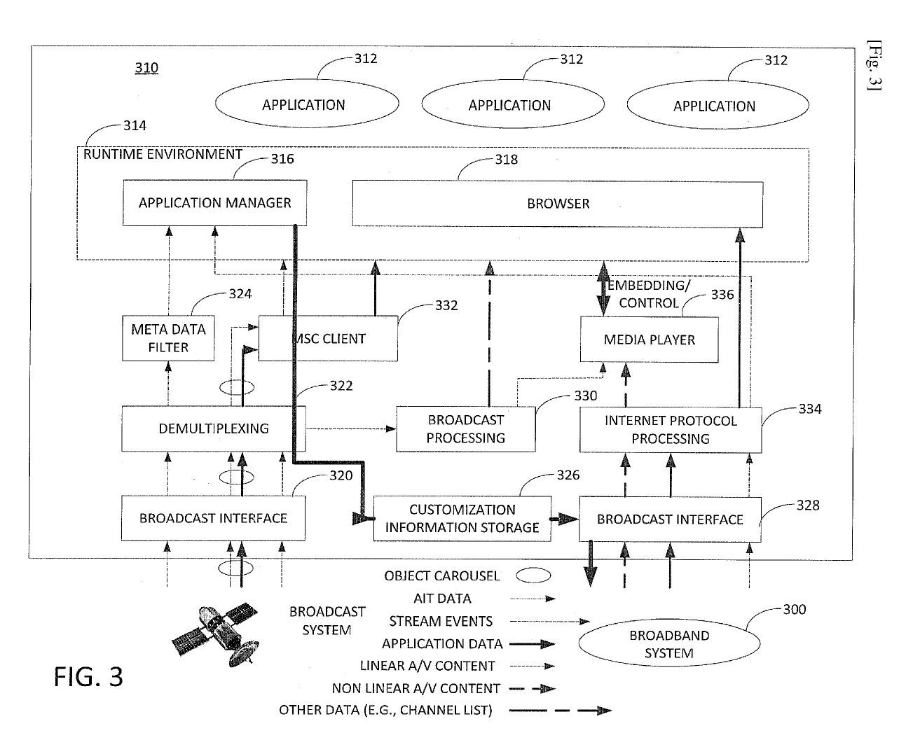

FIG. 3 is a block diagram of an exemplary terminal 310 the receives metadata, linear A/V content, an application, and/or a stream event from a broadcasting company through a broadcast interface 320, and provides the received information to an metadata based filter 324 a Media Storage and Control (MSC) client 332 and a broadcast processor 330 through a demultiplexer 322. The MSC client 332 may recover the data streams and provides the recovered data streams to a runtime environment processor 314. The terminal 310 may include a customization information storage 326.

The runtime environment processor 314 refers to an abstract component that executes interactive applications 312. A browser 318 and an application manager 316 form the runtime environment processor 314. Note that additional elements may be present within the runtime environment. The application manager 316 evaluates data received through the metadata based filter 324 and controls the life cycle of an interactive application. The browser 318 executes an interactive application and responds to an operation of an interactive application.

As in a standard Digital Video Broadcasting (DVB) terminal, linear A/V content may be processed by the broadcast processor 330. The broadcast processor 330 is equipped with all DVB functions of the standard DVB terminal. The broadcast processor 330 may provide additional information and functions such as a channel list, an Event Information present/following (EIT p/f) table, and a tuning function to the runtime environment processor 314. If an application 312 modifies (scales and embeds) linear A/V content through a user interface, a media player 336 operates. The media player 336 has functions to process A/V content.

A broadband interface 328 provides Internet connectivity to the terminal 310. The terminal 310 may request to an Internet server of an application provider through the broadband interface 328 and may receive non-linear A/V content such as Content on Demand (CoD). An Internet protocol processor 334 provides functions required for the terminal 310 to process data received from the Internet. More particularly, the Internet protocol processor 334 provides application data to the runtime environment processor 314 and non-linear A/V data to the media player 336.

The application manager 316 checks information included in the metadata received from a broadcasting company through the broadcast interface 320 to determine whether an application corresponding to the metadata supports customization by interpreting the metadata.

When receiving video/image/graphics content (i.e., video, image or graphics content) it is desirable to include sufficient flexibility in the receiving device such that the particular display capabilities of the device may be used to select the appropriate content to improve the viewing experience. In particular, when the video/image/graphics content is 1280 pixels horizontally by 720 pixels vertically (e.g., HD 720) it is desirable to display the video/image/graphics content at this resolution on the display. In particular, when the video/image/graphics content is 1152 pixels horizontally by 864 pixels vertically (e.g., XGA+) it is desirable to display the video/image/graphics content at this resolution on the display. In particular, when the video/image/graphics content is 1920 pixels horizontally by 1080 pixels vertically (e.g., HD1080) it is desirable to display the video/image/graphics content at this resolution on the display. In particular, when the video/image/graphics content is 1600 pixels horizontally by 1200 pixels vertically (e.g., UXGA) it is desirable to display the video/image/graphics content at this resolution on the display. In particular, when the video/image/graphics content is 2048 pixels horizontally by 1080 pixels vertically (e.g., 2K) it is desirable to display the video/image/graphics content at this resolution on the display. In particular, when the video/image/graphics content is 3840 pixels horizontally by 2160 pixels vertically it is desirable to display the video content at this resolution on the display. In particular, when the video/image/graphics content is 4096 pixels horizontally by 2160 pixels vertically (e.g., 4K) it is desirable to display the video/image/graphics content at this resolution on the display. In other words, it is desirable to display the video/image/graphics content at a preferable display resolution available in order to improve the experience for the viewer. By way of example, if an image is smaller than the maximum resolution and knowing the maximum physical resolution/dots-per-inch/logical resolution, the system can determine which of a plurality of candidate images should be displayed. In some cases, the candidate images may not correspond to the same content. In addition, it is desirable to select among the available video resolutions for the particular device characteristics. In addition, each of the display resolutions may have a different aspect ratio. For example, some of the aspect ratios may include 4:3, 3:2, 16:9, 5:3, 5:4, 21:9, and/or 1:1. With this wide multitude of potential display resolutions together with a wide multitude of aspect ratios, it is desirable to include a manner by which the display characteristic of the device may be effectively determined so that the content provider does not need to be capable of providing the content to the device in a nearly unlimited number of different formats.

In one case, the content (for example, video, images, or graphics) from the provider may be provided at a defined resolution, such as 1280 by 720 with an aspect ratio of 16:9, and require the terminal to reformat the video content to a different format, such as 4096 by 2160 with an aspect ratio of 16:9 more suitable for a particular display. However, the reformatting of the video content tends to result in a substantially lower image quality than if the original 4096 by 2160 content was provided, if available, from the service provider.

Larger video/image/graphics resolution would mean larger file sizes and therefore longer download time (assuming the same bandwidth). It is therefore desirable to download video/image/graphics that do not appear to be visually degraded (which would be the case when upsampling smaller resolution video/image/graphics) and which at the same time do not delay downloads inordinately.

Application developers may choose to adaptively provide higher resolution video/images/graphics for devices with higher dots-per-inches (i.e., higher resolution) to prevent images from appearing inordinately small.

The runtime environment should determine the physical resolution of the application graphics plane for displaying the video content thereon. The physical resolution of the application graphics plane refers to the maximum display capabilities of the device, such as whether the device is capable of displaying 1280 by 720 pixel content or whether the device is capable of displaying 4096 by 2160 pixel content. In this manner, the service provider and/or the terminal can determine the preferable video/image/graphics content from the available content that may be provided. In some case it may be desirable to provide the exact same resolution content whose resolution matches the terminal resolution. In other cases it may be desirable to provide the same resolution content whose resolution corresponds to (e.g., such as proportional to) the terminal resolution in some manner. In some cases it may be desirable to provide a higher resolution content that is down-sampled by the terminal for optimal viewing conditions. In other cases, it may be desirable to provide a lower resolution content that is up-sampled by the terminal for optimal viewing conditions. In some cases, the available bandwidth may be used as a basis, at least in part, to make a determination of which content is preferable. In other cases, the anticipated quality of the resulting content (whether up-sampled or down-sampled) may be used as a basis to make a determination of which content is preferable. In some cases, the physical device dotsper-inch measure may be used as a basis, at least in part, to make a determination of which content is preferable. In some cases, the logical plane dots-per-inch may be used as a basis, at least in part, to make a determination of which content is preferable.

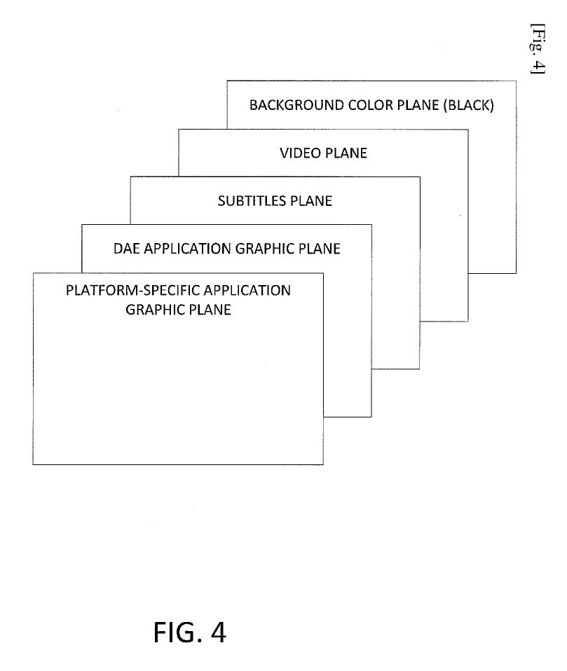

Referring to FIG. 4, digital TV terminals typically have multiple logical planes for displaying graphics, subtitles, video and background color.

The logical planes may be defined as follows:
The “Background color plane” displays a single uniform color e.g. black.
The “Video plane” is used to display video. Streamed video may appear to be presented in a plane other than the logical video plane.
The “Subtitles plane” is used to display subtitles.
The “application graphic plane” is used to display any running applications. The logical resolution of this plane may be given by the <width> and <height> elements of the capability description.
The “Platform-specific application graphic plane” is used to display applications such as native system menus, banners or pop-ups.

The runtime environment should determine the logical resolution of the application graphics plane for displaying the video content thereon. The logical resolution of the application graphics plane refers to the display resolution of the rendering program of the device, such as whether the device is rendering image/graphics/video content on the display at 1280 by 720 or whether the device is rendering video content on the display at 4096 by 2160. For example, the display may be capable of rendering content at 4096 by 2160 but the rendering program, such as a browser, is rendering video/image/graphics content on the display at 1280 by 720. This difference in resolution between the logical and physical characteristics of the device may be determined between the rendering program (e.g., browser) and/or the settings of the device (e.g., operating system or otherwise selecting the physical resolution of the device). In this manner, the service provider and/or the terminal can determine the preferable video/image/graphics content from the available content that is available. In some case it may be desirable to provide the exact same resolution content whose resolution matches the terminal resolution. In some cases it may be desirable to provide a higher resolution content that is down-sampled by the terminal for optimal viewing conditions. In other cases, it may be desirable to provide a lower resolution content that is up-sampled by the terminal for optimal viewing conditions. In some cases, the available bandwidth may be used as a basis, at least in part, to make a determination of which content is preferable. In other cases, the anticipated quality of the resulting content (whether up-sampled or down-sampled) may be used as a basis to make a determination of which content is preferable. In some cases, the physical device dots-per-inch measure may be used as a basis, at least in part, to make a determination of which content is preferable. In some cases, the logical plane dots-per-inch may be used as a basis, at least in part, to make a determination of which content is preferable.

In some cases, it is desirable for the service provider and/or the terminal to determine which video/image/graphics content to provide based upon both the physical resolution of the application graphics plane of the device and the logical resolution of the application graphics plane of the device. In an example, when the physical resolution and the logical resolution are sufficiently different, such as the physical resolution being significantly greater than the logical resolution, it may be desirable to provide the video/image/graphics content at a higher resolution than the logical resolution that is then subsequently down-sampled by the terminal.

In some cases, it is desirable for the service provider and/or the terminal to determine which video/image/graphics content to provide based upon both the physical dotsper-inch measure of the application graphics plane of the device and the logical dotsper-inch measure of the application graphics plane of the device. In an example, when the physical dots-per-inch and the logical dots-per-inch are sufficiently different, such as the physical dots-per-inch being significantly greater than the logical dots-per-inch, it may be desirable to provide the video/image/graphics content which was designed to be rendered on a display with physical dots-per-inch measure higher than the logical dots-per-inch under consideration. The image may be subsequently down-sampled by the terminal.

The runtime environment should determine the aspect ratio of the device's logical (and/or physical) resolution of the application graphics plane for displaying the video/image/graphics content thereon. The logical aspect ratio of the application graphics plane refers to the display aspect ratio of the rendering program of the device, such as whether the device is rendering video/image/graphics content on the display at 16:9 or 21:9. The physical aspect ratio of the application graphics plane refers to the display aspect ratio of the device. In this manner, the service provider and/or the terminal can determine the preferable video/image/graphics content from the available content that may be provided. In some cases it may be desirable to provide a first aspect ratio rather than a second available aspect ratio. In other cases, the anticipated quality of the resulting content (whether changed in aspect ratio in a first manner or changed in aspect ratio in a second manner) may be used as a basis to make a determination of which content is preferable.

One of the features of cascaded style sheets is that they specify how a document is to be presented on different media, e.g., on a screen, on paper, with a speech synthesizer, with a braille device, etc. Certain CSS properties are only designed for certain media (e.g., the ‘page-break-before’ property only applies to paged media). On occasion, however, style sheets for different media types may share a property, but require different values for that property. For example, the ‘font-size’ property is useful both for screen and print media. The two media types are different enough to require different values for the common property; for example, a document will typically need a larger font on a computer screen than on paper. Therefore, it is necessary to express that a style sheet, or a section of a style sheet, applies to certain media types.

Syntactically, media features resemble CSS properties: they have names and accept certain values. There are, however, several important differences between properties and media features:
Properties are used in declarations to give information about how to present a document. Media features are used in expressions to describe requirements of the output device.
Most media features accept optional ‘min-’ or ‘max-’ prefixes to express “greater or equal to” and “smaller or equal to” constraints. This syntax is used to avoid “<” and “>” characters which may conflict with HTML and extensible markup language (XML). Those media features that accept prefixes will most often be used with prefixes, but can also be used alone.
Properties always require a value to form a declaration. Media features, on the other hand, can also be used without a value. For a media feature feature,(feature) will evaluate to true if (feature:x) will evaluate to true for a value x other than zero or zero followed by a unit identifier (i.e., other than 0, 0px, 0em, etc.). Media features that are prefixed by min and/or max cannot be used without a value. When a media feature prefixed with min and/or max is used without a value it makes the media query malformed.
Properties may accept more complex values, e.g., calculations that involve several other values. Media features only accept single values; for example, one keyword, one number, or a number with a unit identifier. (The only exceptions are the ‘aspect-ratio’ and ‘device-aspect-ratio’ media features.)

One technique to access the application graphical plane logical resolution and aspect ratio information may be obtained using a cascade style sheet (CSS) query, and preferably using a media query. For example, cascade style sheet version 2.1 and/or 3.0 may be supported. A media query may consist of a media type and zero or more expressions, which are generally any valid unit of code that resolves to a value, that check for the conditions of particular media features. In an example, the check for the conditions may correspond to a relational expression consisting of two or more expressions whose values are compared to determine whether the relationship stated by the relational operator is satisfied. The result of the relational expression is true if the relation specified by the operator is satisfied; otherwise the result is false. Typically, a media query is a logical expression that is either true or false. A media query is true if the media type of the media query matches the media type of the device where the user agent is running and all expressions in the media query are true.

In one example, the px unit may be a unit related to CSS. In some cases, it may not be related to the current font and also not related to the absolute units. The px unit may be defined to be small but visible, and such that a horizontal 1px wide line can be displayed with sharp edges (no anti-aliasing). What is sharp, small and visible may depend on the device and the viewing distance. Thus, the px may not be defined as a constant length, but as something that depends on the type of device and its typical use.

In another example, the px unit corresponds to actual pixels on the screen.

In another example, the px unit corresponds to logical pixels on the screen.

In another example, the px unit may correspond to the following:

For a CSS device, these dimensions are either anchored (i) by relating the physical units to their physical measurements, or (ii) by relating the pixel unit to the reference pixel. For print media and similar high-resolution devices, the anchor unit should be one of the standard physical units (e.g., inches, centimeters, etc). For lower-resolution devices, and devices with unusual viewing distances, it is recommended instead that the anchor unit be the pixel unit. For such devices it is recommended that the pixel unit refer to the whole number of device pixels that best approximates the reference pixel.

The reference pixel is the visual angle of one pixel on a device with a pixel density of 96 dpi and a distance from the reader of an arm's length. For a nominal arm's length of 28 inches, the visual angle is therefore about 0.0213 degrees. For reading at arm's length, 1px thus corresponds to about 0.26 mm ( 1/96 inch).

In particular, the media feature device-width of the CSS media query may return the logical width of the application graphic plane resolution. The ‘device-width’ media feature describes the width of the rendering surface of the output device. For continuous media, this is the width of the screen. The px unit (e.g., pixels) may be supported for this. In particular, the media feature device-height of the CSS media query may return the logical height of the application graphic plane resolution. The ‘device-height’ media feature describes the height of the rendering surface of the output device. For continuous media, this is the height of the screen. The px unit (e.g., pixels) may be supported for this. In particular, the media feature device-aspect-ratio of the CSS media query may return the logical aspect ratio of the application graphic plane resolution. The ‘device-aspect-ratio’ media feature is defined as the ratio of the value of the ‘device-width’ media feature to the value of the ‘device-height’ media feature. In this manner, the CSS media query may determine in some manner the width, the height, and/or the aspect ratio of the logical application graphic plane.

As a result of the CSS media query being limited to returning a “true” or a “false” condition, the CSS media query does not directly support providing the resolution to the requester. Therefore, the system needs to query the height, weight, and/or aspect ratio for each potentially desired rendering. For example, the system may check to determine whether it is capable of displaying standard definition content which if true, then the system may check to determine whether it is capable of displaying 2K content which if true, the system may check to determine whether it is capable of displaying 4K content, etc. Therefore, the process to determine the most appropriate video resolution tends to be a burdensome process and may require many queries. This process of requiring many queries occurs even in the event that only a particular limited subset of display resolutions are permitted with a limited number of aspect ratios.

In another embodiment, media feature device-width of the CSS media query may have the value equal to <width> element of the capability description. The media feature device-height of the CSS media query may have the value equal to <height> element of the capability description. The media feature device-aspect-ratio of the CSS media query may return the value equal to <width>/<height>, with <width> and <height> element from the capability description and ‘/’ indicating a division operation. It is noted that the capability description may relate to the physical graphics resolution.

In another embodiment, the media feature device-width of the CSS media query may have the value of 1280 px. The media feature device-height of the CSS media query may have the value of 720 px. The media feature device-aspect-ratio of the CSS media query may return the value of 16:9.

In some embodiments it may be desirable for the terminal to be capable of providing an indication of the supported application graphic plane logical resolutions in a profile of the terminal. While the terminal could provide a nearly unlimited number of permutations of the resolution of the application graphic logical resolutions, such an expansive capability results in undue complications for the content provider in selecting the desirable video content. A more preferable technique is to select a limited number of profiles, such as less than 10 profiles, and more preferably less than 5 profiles, to indicate the available application graphic plane logical resolutions. The profile may be included in a file, for example an XML file, at the terminal which has a string, which represents the capabilities of the terminal. In this manner, the application operating on the terminal can request the string from the terminal which describes the capabilities of the terminal. Based upon the string, the application may then determine the capabilities of the terminal which may be used in selecting the characteristics of the content to be displayed thereon.

One set of profiles may include a UI Profile String (1) “OITF_HD_UIPROF” as supporting 1280×720 application graphic plane resolution, (2) “OITF_FULL_HD_UIPROF” as supporting 1920×1080 application graphic plane resolution, and (3) “OITF_UHD_UIPROF” as supporting 3840×2160 application graphic plane resolution. These strings may be stored in a name property or attribute of a ui_profile element. In another example the UI Profile String “OITF_UHD_UIPROF” indicates support of 4096×2160 application graphic plane resolution.

The application may have access to the function hasCapability( ) method of the application/oipfCapabilities embedded object to dynamically query the UI profile supported by the terminal. As a result of accessing this method, the application receives the string and examines the contents of the string to determine the devices capabilities. The name property or attribute of a ui_profile element, may be structured in an xml format, to indicate the xmlCapabilities property of the application/oipfCapabilities embedded object. They may be used in hypertext transfer protocol (HTTP) User-Agent header for applications retrieving data through HTTP. As it may be observed, this technique does not provide the resolution of the device, but does indicate what types of application graphic plane resolutions the device supports as defined by the string. In an alternative embodiment, the name attribute or property of a ui_profile element may contain any other suitable string which indicates what types of application graphic plane resolution the device supports.

Another technique to determine the actual resolution of the display, together with its aspect ratio if desired, may be accomplished using an application program interface (API). As illustrated in Table 2 below, an API may return an Integer (e.g., see upper left hand of table) based upon calling the API name getApplicationGraphicsPlaneWidth( ). The API returns the actual device width of the application graphic plane in pixels.

TABLE 2
Integer getApplicationGraphicsPlaneWidth( )

| | |
|---|---|
| Description | Returns the actual device width of the application graphic |
| | plane in pixels |

As illustrated in Table 3 below, an API may return an Integer (e.g., see upper left hand of table) based upon calling the API name getApplicationGraphicsPlaneHeight( ). The API returns the actual device height of the application graphic plane in pixels.

TABLE 3
Integer getApplicationGraphicsPlaneHeight( )

| | |
|---|---|
| Description | Returns the actual device height of the application graphic |
| | plane in pixels |

As illustrated in Table 4 below, an API may return an Integer (e.g., see upper left hand of table) based upon calling the API name getApplicationGraphicsPlaneDpi( ). The API returns the actual device dots-per-inch of the application graphic plane.

TABLE 4
Integer getApplicationGraphicsPlaneDpi( )

| | |
|---|---|
| Description | Returns the number of actual device dots-per-inch of the |
| | application graphic plane |

As illustrated in Table 5 below, an API may be called based upon the API name onApplicationGraphicsPlaneResolutionChanged( ). The function is called when the logical resolution of the application graphic plane is changed. This function may be called in response to an application graphics plane resolution change initiated by an application or the device. In this manner, if the graphical resolution of the device changes, then the system may accommodate this change by modification of the content to be provided, if desired. In this manner, the system may take adaptive action upon the occurrence of an event. In an example, the function corresponds to a JavaScript function. In an embodiment the function onApplicationGraphicsPlaneResolutionChanged( ) may be called in response to an application graphics plane resolution change without consideration of what (e.g., an application, device, process, or system) initiated the change.

TABLE 5
Function onApplicationGraphicsPlaneResolutionChanged( )

| | |
|---|---|
| Description | The function that is called when the logical resolution of the |
| | application graphic plane is changed. This function may be |
| | called in response to an application graphics plane |
| | resolution change initiated by an application. |

The terminal should provide some limitations on the amount a video/image/graphics can be scaled so that it doesn't increase and/or decrease the resolution to an extent that the quality of the content is excessively degraded. Such scaling limitations may be defined as follows in Table 6:

TABLE 6

| | |
|---|---|
| Value | Charactertistic |

| | |
|---|---|
| Video | Terminals shall be able to |
| scaling | present video at sizes down |
| | to ⅛-by ⅛ of the width and |
| | height of the logical video |
| | plane. Terminals shall be |
| | able to scale video down to |
| | ¼ by ¼ and should be able |
| | to scale video down to ⅛ by |
| | ⅛. For sizes between ¼ by |
| | ¼ and ⅛ by ⅛, terminals |
| | which cannot scale video |
| | shall crop the video instead |
| | and display it centered in the |
| | according video object of the |
| | Hybrid Broadcast Broadband |
| | TV application graphics |
| | plane. |
| | Terminals shall be able to |
| | scale video up to 2 × 2 of the |
| | width and height of the |
| | logical video plane. |
| | Within these limits, any |
| | arbitrary scaling factor shall |
| | be allowed. The aspect ratio |
| | of decoded video shall be |
| | preserved at all scaling |
| | factors. |

In a variant embodiment the video scaling requirement in Table 6 may be changed as follows:

Terminals shall be able to scale video up to 4×4 of the width and height of the logical video plane.

In a variant embodiment the video scaling requirement in Table 6 may be changed for a 4K display as follows:

When the CSS media query @media (device-width: 3840) and (device-height: 2160) is true the terminals shall be able to scale video up to 4×4 of the width and height of logical video plane.

In a variant embodiment the video scaling requirement in Table 6 may be changed for a 4K display as follows:

When the CSS media query @media (device-width: 3840) is true the terminals shall be able to scale video up to 4×4 of the width and height of logical video plane.

In a variant embodiment the video scaling requirement in Table 6 may be changed for a 4K display as follows:

When the CSS media query @media (device-height: 2160) is true the terminals shall be able to scale video up to 4×4 of the width and height of logical video plane.

In some cases, it may be sufficient to include a requirement on a minimum width for an application in portrait mode and/or a minimum width for an application in landscape mode. The px unit may be supported for this.

The API may include other capabilities, if desired. Depending on the particular density of the pixels of the device, it may be desirable to modify the rendering of the content thereon to achieve an improved display quality. For example, the following API as shown in Table 7, referred to as getApplicationGraphicsPlaneDpiWidth( ), may be included that returns the number of actual device dots-per-inch along the width of the application graphic plane. In an example along the width corresponds to the “x” direction and along the height corresponds to the “y” direction. By way of example, a rectangular mobile phone oriented in the landscape mode, may have an “x” direction in the longer horizontal direction and a “y” direction in the shorter vertical direction. By way of example, a rectangular mobile phone oriented in the portrait mode, may have an “x” direction in the shorter horizontal direction and a “y” direction in the longer vertical direction.

TABLE 7
Integer getApplicationGraphicsPlaneDpiWidth( )

| | |
|---|---|
| Description | Returns the number of actual device dots-per-inch along the |
| | width of the application graphic plane |

For example, the following API as shown in Table 8, referred to herein as getApplicationGraphicsPlaneDpiHeight( ) may be included that returns the number of actual device dots-per-inch along the height of the application graphic plane.

TABLE 8
Integer getApplicationGraphicsPlaneDpiHeight( )

| | |
|---|---|
| Description | Returns the number of actual device dots-per-inch along the |
| | height of the application graphic plane |

For example, the following API as shown in Table 9, referred to herein as isStereo3DState( ), may be included that returns a “true” condition if the stereo 3D state of the device is On, otherwise returns “false”.

TABLE 9
Bool isStereo3DState( )

| | |
|---|---|
| Description | Returns TRUE if the stereo 3D state of the device is ON |
| | otherwise returns FALSE. |

For example, the following API as shown in Table 10, referred to herein as getOrientation( ) may be included that returns the orientation of the device, such as vertical or horizontal. This orientation, particularly in the case of a mobile device, tends to indicate whether the device is in a landscape orientation or a portrait orientation. In addition, the orientation may be coupled with the height and width (physical and/or logical) of the device so that any existing ambiguity over the perceived height and width of the content may be determined. For example, the API may return 1 to indicate the device is in landscape orientation and may return 0 to indicate the device is in portrait orientation.

TABLE 10
Integer getOrientation( )

| | |
|---|---|
| Description | Returns 1 to indicate the device is in landscape orientation. |
| | Returns 0 to indicate the device is in portrait orientation. |

For example, the following API as shown in Table 11, referred to herein as getPlaneWidth(Integer planeIndicator), may be included that returns the actual device width of the plane indicated by planeIndicator in pixels. The plane indicator may indicate a number of different planes, such as the application graphics plane, a background color plane, a video plane, a subtitle plane, and/or a platform specific application graphics plane.

TABLE 11
Integer getPlaneWidth( Integer planeIndicator )

| | |
|---|---|
| Description | Returns the actual device width of the plane indicated by |
| | planeIndicator in pixels |
| Input | planeIndicator equal to 1 indicates application graphics |
| | plane |
| | planeIndicator equal to 2 indicates background color plane |
| | planeIndicator equal to 3 indicates video plane |
| | planeIndicator equal to 4 indicates subtitle plane |
| | planeIndicator equal to 5 indicates platform specific |
| | application graphic plane |

For example, the following API as shown in Table 12, referred to herein as getPlaneHeight(Integer planeIndicator), may be included that returns the actual device height of the plane indicated by planeIndicator in pixels. The plane indicator may indicate a number of different planes, such as the application graphics plane, a background color plane, a video plane, a subtitle plane, and/or a platform specific application graphics plane.

TABLE 12
Integer getPlaneHeight( Integer planeIndicator )

| | |
|---|---|
| Description | Returns the actual device height of the plane indicated by |
| | planeIndicator in pixels |
| Input | planeIndicator equal to 1 indicates application graphics |
| | plane |
| | planeIndicator equal to 2 indicates background color plane |
| | planeIndicator equal to 3 indicates video plane |
| | planeIndicator equal to 4 indicates subtitle plane |
| | planeIndicator equal to 5 indicates platform specific |
| | application graphic plane |

For example, the following API as shown in Table 13, referred to herein as getPlaneDpi(Integer planeIndicator), may be included that returns the number of actual device dots-per-inch of the plane indicated by planeIndicator. The plane indicator may indicate a number of different planes, such as the application graphics plane, a background color plane, a video plane, a subtitle plane, and/or a platform specific application graphics plane.

TABLE 13
Integer getPlaneDpi( Integer planeIndicator )

| | |
|---|---|
| Description | Returns the number of actual device dots-per-inch of the |
| | plane indicated by planeIndicator |
| Input | planeIndicator equal to 1 indicates application graphics |
| | plane |
| | planeIndicator equal to 2 indicates background color plane |
| | planeIndicator equal to 3 indicates video plane |
| | planeIndicator equal to 4 indicates subtitle plane |
| | planeIndicator equal to 5 indicates platform specific |
| | application graphic plane |

For example, the following API as shown in Table 14, referred to herein as getPlaneDpiWidth(Integer planeIndicator), may be included that returns the number of actual device dots-per-inch along the width of the plane indicated by planeIndicator. The plane indicator may indicate a number of different planes, such as the application graphics plane, a background color plane, a video plane, a subtitle plane, and/or a platform specific application graphics plane.

TABLE 14
Integer getPlaneDpiWidth( Integer planeIndicator )

| | |
|---|---|
| Description | Returns the number of actual device dots-per-inch along the |
| | width of the plane indicated by planeIndicator |
| Input | planeIndicator equal to 1 indicates application graphics |
| | plane |
| | planeIndicator equal to 2 indicates background color plane |
| | planeIndicator equal to 3 indicates video plane |
| | planeIndicator equal to 4 indicates subtitle plane |
| | planeIndicator equal to 5 indicates platform specific |
| | application graphic plane |

For example, the following API as shown in Table 15, referred to herein as getPlaneDpiHeight(Integer planeIndicator), may be included that returns the number of actual device dots-per-inch along the height of the plane indicated by planeIndicator. The plane indicator may indicate a number of different planes, such as the application graphics plane, a background color plane, a video plane, a subtitle plane, and/or a platform specific application graphics plane.

TABLE 15
Integer getPlaneDpiHeight( Integer planeIndicator )

| | |
|---|---|
| Description | Returns the number of actual device dots-per-inch along the |
| | height of the plane indicated by planeIndicator |
| Input | planeIndicator equal to 1 indicates application graphics |
| | plane |
| | planeIndicator equal to 2 indicates background color plane |
| | planeIndicator equal to 3 indicates video plane |
| | planeIndicator equal to 4 indicates subtitle plane |
| | planeIndicator equal to 5 indicates platform specific |
| | application graphic plane |

For example, the following API as shown in Table 16, referred to herein as onStereo3DStateChange(Boolean newState), may be included that is called when the stereo 3D state of the device is changed. The input received may be newState equal to 1 to indicate that the stereo 3D state was enabled, and newState equal to 0 to indicate that the stereo 3D state was disabled.

TABLE 16
function onStereo3DStateChange( Boolean newState )

| | |
|---|---|
| Description | The function that is called when the stereo 3D state of the |
| | device is changed. |
| Input | newState equal to 1 indicates that the stereo 3D state was |
| | enabled. newState equal to 0 indicates that the stereo 3D |
| | state was disabled. |

For example, the following API as shown in Table 17, referred to herein as onOrientationChange(Boolean newState), may be included that is called when the orientation of the device is changed. The input may be newState equal to 1 to indicate that the orientation of the device was changed to landscape, and newState equal to 0 to indicate that the orientation of the device was changed to portrait. In an example, the function corresponds to a JavaScript function.

TABLE 17
function onOrientationChange( Boolean newState )

| | |
|---|---|
| Description | The function that is called when the orientation of the |
| | device is changed. |
| Input | newState equal to 1 indicates that the orientation of the |
| | device was changed to landscape. |
| | newState equal to 0 indicates that the orientation of the |
| | device was changed to portrait. |

For example, the following API as shown in Table 18, referred to herein as onDPIChange(Integer newState), may be included that is called when the DPI of the device is changed. The input may be newState which is the number of dots-per-inch of the device. In an example, the function corresponds to a JavaScript function.

TABLE 18
function onDPIChange( Integer newState )

| | |
|---|---|
| Description | The function that is called when the DPI of the |
| | device is changed. |
| Input | newState is the number of dots-per-inch of the device. |

For example, the following API as shown in Table 19, referred to herein as onDPIWidthChange(Integer newState), may be included that is called when the DPI along the width of the device is changed. The input may be newState which is the number of dots-per-inch along the width of the device. In an example, the function corresponds to a JavaScript function.

TABLE 19
function onDPIWidthChange( Integer newState )

| | |
|---|---|
| Description | The function that is called when the DPI along the width |
| | of the device is changed. |
| Input | newState is the number of dots-per-inch along the width |
| | of the device. |

For example, the following API as shown in Table 20, referred to herein as onDPIHeightChange(Integer newState), may be included that is called when the DPI along the height of the device is changed. The input may be newState which is the number of dots-per-inch along the height of the device. In an example, the function corresponds to a JavaScript function.

TABLE 20
function onDPIHeightChange( Integer newState )

| | |
|---|---|
| Description | The function that is called when the DPI along the height |
| | of the device is changed. |
| Input | newState is the number of dots-per-inch along the height |
| | of the device. |

In another embodiment only a limited number of the planeIndictor values may be defined, such as for example, planeIndicator equal to 1 indicates application graphics plane and planeIndicator equal to 0 indicates video plane.

Referring to Table 21 below, some of the capabilities supported for the UI profile may be defined as illustrated.

TABLE 21

| UI Profile Name | Default values |
|---|---|
| ″OITF_HD_UIPROF″ | <width>1280</width> |
| | <height>720</height> |
| | <colors>high</colors> |
| | <hscroll>false</hscroll> |
| | <vscroll>true</vscroll> |
| | <font type=″sans-serif″ defaultsize=″24″>Tiresias |
| | Screenfont</font> with support for the Unicode |
| | character range “Generic Application Western |
| | European Character Set” as defined in Annex C |
| | of [TS 102 809]. |
| | <key>VK_BACK</key> |
| | <colorkeys>true</colorkeys> |
| | <navigationkeys>true</navigationkeys> |
| | <numerickeys>true</numerickeys> |
| | <pointer>false</pointer> |
| | <security protocolNames=″ssl |
| | tls″>true</security> |
| | <overlay>per-pixel</overlay><!-- whereby at |
| | least one level of partial transparency between |
| | graphics and video must be supported as per the |
| | minimum requirements of section 9.1 --> |
| | <overlaylocal>per-pixel</overlaylocal><!-- |
| | whereby at least one level of partial transparency |
| | between graphics and video must be supported |
| | as per the minimum requirements of section 9.1 - |
| | -> |
| | <overlaylocaltuner>per- |
| | pixel</overlaylocaltuner><!-- whereby at least |
| | one level of partial transparency between |
| | graphics and video must be supported as per the |
| | minimum requirements of section 9.1 --> |
| | <overlayIPbroadcast>per- |
| | pixel</overlayIPBroadcast><!-- whereby at least |
| | one level of partial transparency between |
| | graphics and video must be supported as per the |
| | minimum requirements of section 9.1 --> |
| | <notificationscripts>false</notificationscripts> |
| | <save-restore>false</save-restore> |
| ″OITF_FULL_HD_UIPROF″ | Same as OITF_HD_UIPROF, with the following |
| | modifications: |
| | <width>1920</width> <height>1080</height> |
| ″OITF_UHD_UIPROF″ | Same as OITF_HD_UIPROF, with the following |
| | modifications: |
| | <width>3840</width> <height>2160</height> |

In an alternative embodiment the <width> element of “OITF_UHD_UIPROF” may take on the value 4096.

In this document the invention corresponding to the measure dots-per-inch may be replicated for any another suitable measure, for example, pixels-per-inch, or pixels-per-centimeter, or dots-per-centimeter, or dots per px unit.

In this document the invention corresponding to the measure pixels may be replicated for any another suitable measure.

In this document the invention corresponding to the measure px may be replicated for any another suitable measure.

While an application running on the terminal may determine the display resolution of the physical device and perform its processing based upon the determined physical display resolution, this often results in a sub-optimal rendering on the display.

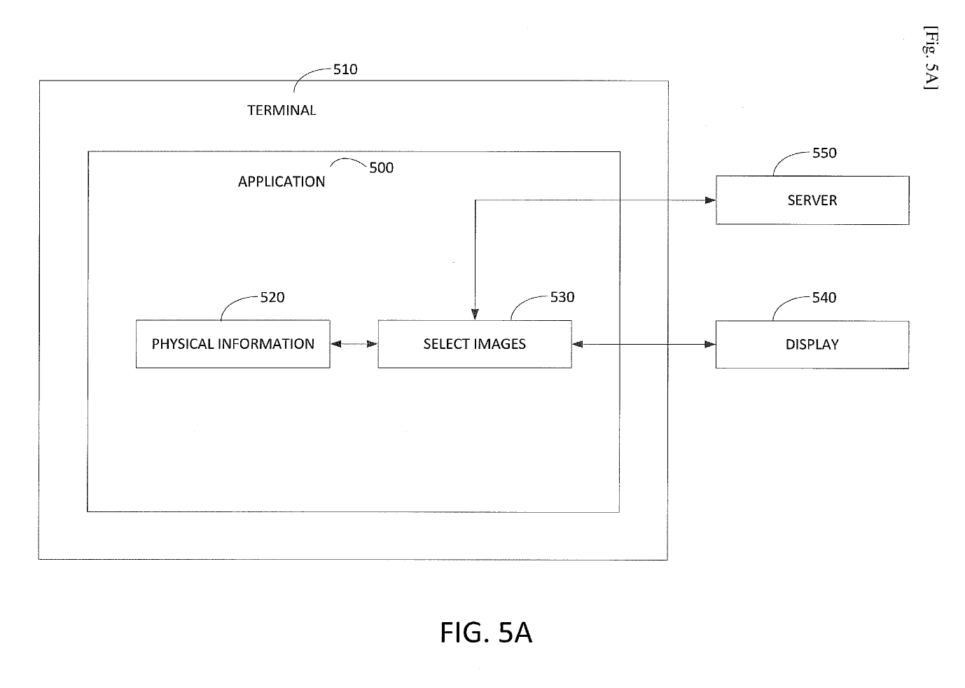

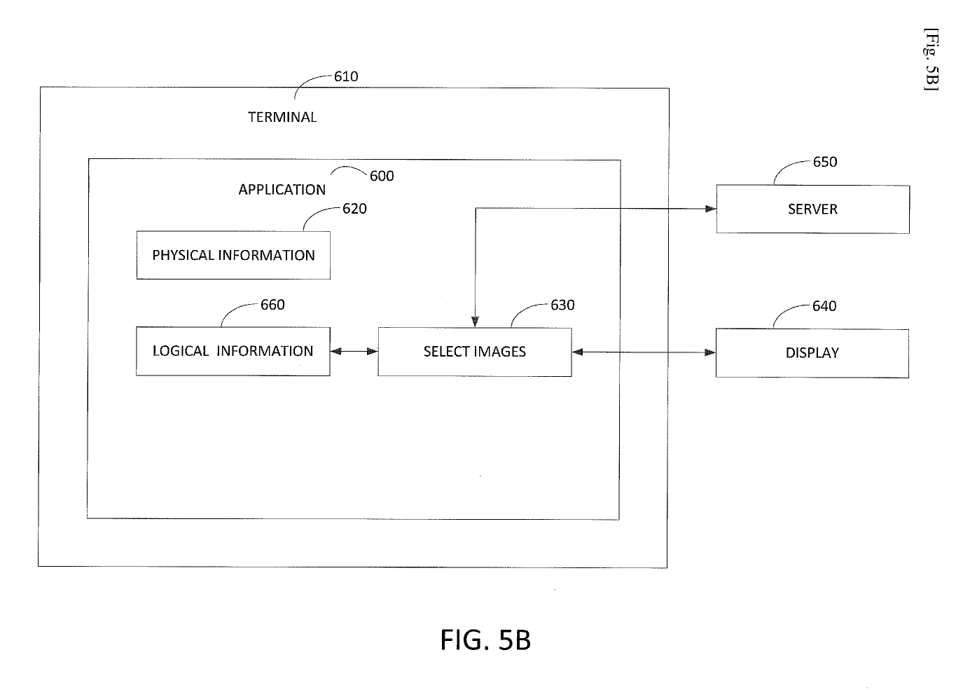

Referring to FIG. 5A, one technique involves an application 500 running on a terminal 510 that includes physical information 520 related to a physical resolution of the physical pixels for displaying an image on the display. The application 500 running on the terminal 510 may select 530 the image to be displayed within the application graphics plane on the display 540 from a set of available images based upon the physical information. Preferably, the selected image is provided to the application from a server 550.

Referring to FIG. 5B, an improved technique involves an application 600 running on a terminal 610 that optionally includes physical information 620 related to a physical resolution of the physical pixels for displaying an image on the display. The application 600 running on the terminal may include logical information 660 related to an application graphics plane that includes a graphics plane resolution of logical pixels. The application 600 running on the terminal 610 may select 630 the image to be displayed within the application graphics plane on the display 640 from a set of available images based upon the logical information related to the graphics plane resolution of logical pixels. Preferably, the graphics plane resolution of logical pixels is different than the physical resolution of the physical pixels. Preferably, the selected image is provided to the application from a server 650. Preferably, the selected image is selected based upon an aspect ratio of the application graphics plane.

While an application running on the terminal may determine if the display resolution of the physical device is a particular predefined resolution and perform its processing based upon the particular predefined resolution.

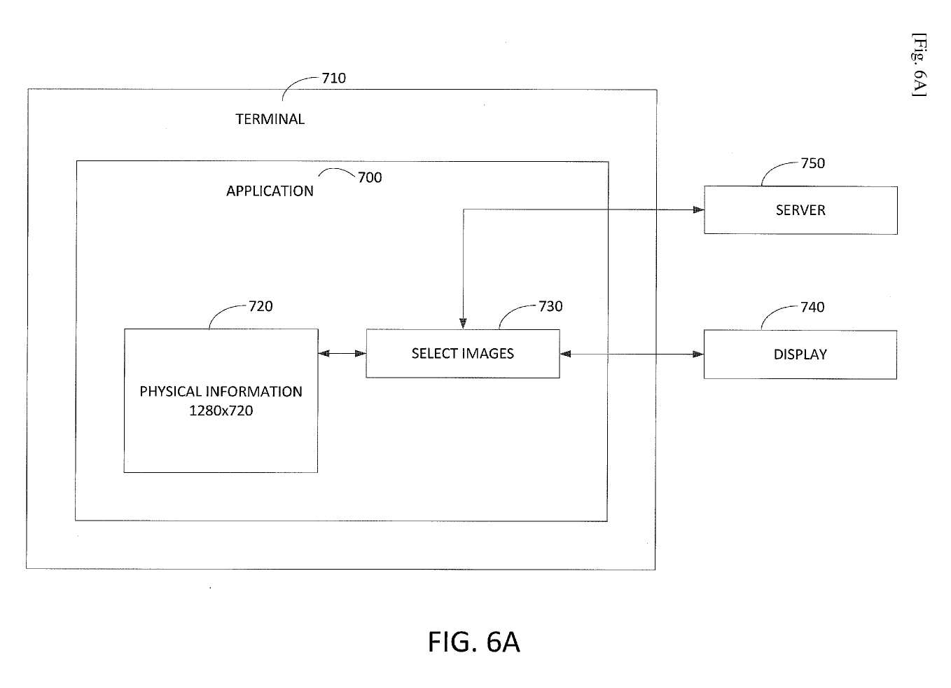

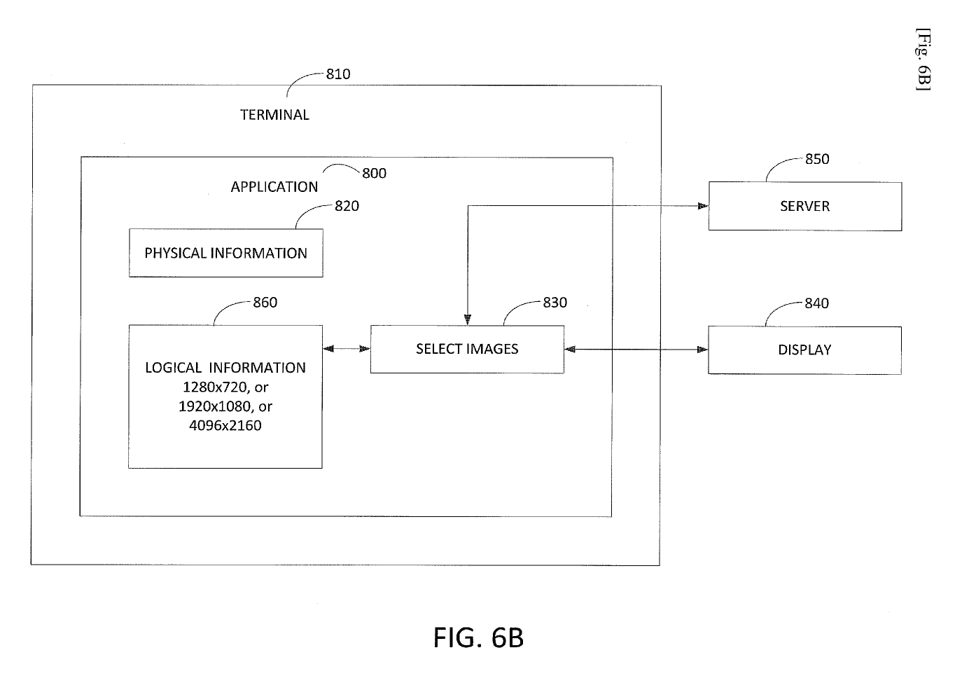

Referring to FIG. 6A, one technique involves an application 700 running on a terminal 710 that includes physical information 720 related to a physical resolution of the physical pixels for displaying an image on the display. In particular, the application determines if the resolution is 1280×720. The application 700 running on the terminal 710 may select 730 the image to be displayed within the application graphics plane on the display 740 from a set of available images based upon the physical information. Preferably, the selected image is provided to the application from a server 750.

Referring to FIG. 6B, one technique involves an application 800 running on a terminal 810 that optionally includes physical information 820 related to a physical resolution of the physical pixels for displaying an image on the display. The application 800 running on the terminal 810 may include logical information 860 related to an application graphics plane that includes a graphics plane resolution of logical pixels. In particular, the application 800 determines if the graphics plane resolution of logical pixels is one of (1) 1280×720, or (2) 1920×1080, or (3) 4096×2160. The application 800 running on the terminal 810 may select 830 the image to be displayed within the application graphics plane on the display 840 from a set of available images based upon the logical information 860 related to the graphics plane resolution of logical pixels. Preferably, the graphics plane resolution of logical pixels is different than the physical resolution of the physical pixels. Preferably, the selected image is provided to the application from a server 850. Preferably, the selected image is selected based upon an aspect ratio of the application graphics plane.

1. A display system for displaying an image on a display comprising:
(a) said display system includes physical information related to a physical resolution of physical pixels for said displaying said image on said display;
(b) said display system includes logical information related to an application graphics plane that includes a graphics plane resolution of logical pixels;
(c) said display system selects said image to be displayed within said application graphics plane on said display from a set of available images based upon said logical information related to said graphics plane resolution of logical pixels.

2. The display system of claim 1 wherein said graphics plane resolution of logical pixels is different than said physical resolution of physical pixels.

3. The display system of claim 1 wherein said selected image is provided to said display system from a server.

4. The display system of claim 1 wherein said display system further said selects said image to be displayed within said application graphics plane on said display based upon an aspect ratio of said application graphics plane.

5. The display system of claim 1 further comprising a runtime environment that said selects said image to be displayed within said application graphics plane on said display.

6. The display system of claim 5 wherein said runtime environment is at a terminal.

7. The display system of claim 5 wherein said runtime environment is at a server.

8. The display system of claim 5 wherein said runtime environment is running on a computing device that is connected to said display.

9. The display system of claim 1 wherein said display system includes said display.

10. A display system for displaying an image on a display comprising:
(a) said display system includes physical information related to a physical resolution of physical pixels for said displaying said image on said display;
(b) said display system includes logical information related to an application graphics plane that includes a graphics plane resolution of logical pixels;
(c) said display system selects said image to be displayed within said application graphics plane on said display from a set of available images based upon a profile indicator of said display system.

11. The display system of claim 10 wherein said profile indictor includes at least one of a OTIF_HD_UIPROF indicator, a OTIF_FULL_HDUIPROF indicator, and a OITF_UHD_UIPROF indicator.

12. The display system of claim 11 wherein said profile indicator includes said OTIF_HD_UIPROF indicator, and said OTIF_HD_UIPROF indicator corresponds to a 1280×720 said application graphics plane.

13. The display system of claim 11 wherein said profile indicator includes said OTIF_FULL_HDUIPROF indicator, and said OTIF_FULL_HDUIPROF indicator corresponds to a 1920×1080 said application graphics plane.

14. The display system of claim 11 wherein said profile indicator includes said OITF_UHD_UIPROF indicator, and said OITF_UHD_UIPROF indicator corresponds to a 3840×2160 said application graphics plane.

15. The display system of claim 10 further comprising a runtime environment that said selects said image to be displayed within said application graphics plane on said display.

16. The display system of claim 15 wherein said runtime environment is at a terminal.

17. The display system of claim 15 wherein said runtime environment is at a server.

18. The display system of claim 15 wherein said runtime environment is running on a computing device that is connected to said display.

19. The display system of claim 10 wherein said display system includes said display.
